(19) United States
(12) Patent Application Publication
(10) Pub. No.: US 2014/0193560 A1
(43) Pub. Date: Jul. 10, 2014

(54) OVERBOIL RING APPARATUS AND COOKING AND HEATING SYSTEM

(71) Applicant: Charles Viancin, Chavanod (FR)

(72) Inventor: Charles Viancin, Chavanod (FR)

(21) Appl. No.: 14/146,843

(22) Filed: Jan. 3, 2014

Related U.S. Application Data
(60) Provisional application No. 61/748,629, filed on Jan. 3, 2013.

(51) Int. Cl. A47J 36/08

(52) U.S. Cl. CPC A47J 36/08
USPC 426/523; 126/385.1; 426/520

(57) ABSTRACT

The present invention relates to an overboil ring apparatus which can be used when liquids are being heated or stirred. The ring is placed on a pot, pan, or cooking basin. The ring has a symmetric and decreasing diameter at different heights of the ring and having an opening therein. The ring can be formed of silicone.

### FIELD OF THE INVENTION

The present invention relates an overboil ring apparatus and cooking and heating system, and a method for cooking and heating food and other products in boiling liquids.

### BACKGROUND OF THE INVENTION

Various tools for cooking and heating products are known. Cooking techniques and ingredients vary widely across the world, reflecting unique environmental, economic, and cultural traditions, and typically require in the process of preparing foods, the use of heat. Heating liquids is often required to produce chemical reactions.

U.S. Patent Application Publication No. 2011/0061544 describes a cooking vessel top including a passage opening or passage openings have at least one flat closure part connected to the cooking vessel top, which in the rest state do no contact a boiling or foaming liquid which essentially closes the passage opening or passage openings allocated to it and can be moved into an opening position by the opening force that develops on contact with the boiling or foaming liquid, in which the passage opening or passage openings are at least partially released.

U.S. Pat. No. 6,105,811 describes an ergonomic cooking pan cover designed for fitting on and covering the top of various sizes of pots, pans and skillets for venting steam and preventing boil-over. The cooking pan cover includes a concave shaped cooking lid with an ergonomic handle. The ergonomic handle includes an upwardly extending knob mounted on top of an annular shaped knob base. The knob is used for gripping and lifting the pan cover. Around an outer circumference of the knob base are a plurality of downwardly extending base posts. The base posts are attached to a portion of the cooking lid. The concave shaped cooking lid includes a series of downwardly extending step-down rings. The rings are designed to center the cooking lid on the sides of the top of standard size cooking utensils from 6 to 12 inches in diameter. A center of the cooking lid is characterized by a raised central member with a closed top portion and an annular steam vent ring therearound. The steam vent ring is angled from the horizontal and includes a plurality of vent holes therein for venting steams and boil-over. The annular steam vent ring with vent holes direct the steam and boil-over outwardly between the bottom of the knob base and the top of the cooking lid thereby reducing the heating of the handle when lifting the cooking pan cover during a cooking operation. The annular shaped knob base is sized to cover the raised central member and the annular steam vent ring with the knob base acting as a splash guard during a boil-over.

It is desirable to provide an overboil apparatus to prevent overboiling a splattering of a food from a pot or pan and which can be used when a liquid is being heated or stirred.

### SUMMARY OF THE INVENTION

The present invention relates to an overboil ring apparatus which can be used when liquids are being heated or stirred. The apparatus protects the user and the cooking surfaces from liquids that may splash, splatter, or boil over the pot, pan, or cooking basin's edges during heating. The ring is placed on a pot, pan, or cooking basin. The ring has a symmetric and decreasing diameter at different heights of the ring. Various sizes of the overboil ring may apparatus can be used for receiving various pots, pans, or cooking basins. Cooking baskets and cooking utensils can be used with the overboil ring apparatus while the apparatus is received on a pot, pan, or cooking basin, to protect the cooking surface and user from splatters or splashes. The cooking baskets and cooking utensils can be received in an opening at the bottom of the overboil ring apparatus.

The overboil ring apparatus can be formed of a flexible material of varying thicknesses. A suitable material for the overboil ring apparatus is silicone. When laying horizontally on a flat surface, where the inner ring of the overboil ring apparatus supports the weight of the product, the ring extends up and outward from the inner ring at an angle of between about 20 degrees and about 60 degrees from the plane of the inner ring, towards the outermost edges of an outer ring.

During use, when liquids inside the pot, pan, or cooking basin are heated or stirred, liquid can splash upwardly along the inner walls of the overboil ring apparatus. The liquid is then caught on the surface of the overboil ring apparatus, and returns to the pot, pan, or cooking basin by gravity. The overboil ring apparatus provides access for the user to the contents of the pot, pan, or cooking basin, for adding products, stirring, smelling, and monitoring the contents being cooked or heated.

The invention will be more fully described by reference to the following drawings.

### BRIEF DESCRIPTION OF THE DRAWINGS

FIG. 1A is a top plan view of the overboil ring apparatus in accordance with the teachings of the present invention.

FIG. 1B is a side plan view of the overboil ring apparatus.

FIG. 2 is a bottom elevational view of the overboil ring apparatus which lays upon a pot, pan, or cooking basin.

FIG. 3 is a side elevation view of the overboil ring apparatus shown at an angle.

FIG. 4 is a side plan view of the overboil ring apparatus.

FIG. 5 is a top and side elevational view of the overboil apparatus.

FIG. 6A is a schematic diagram of the overboil ring apparatus used with a basket.

FIG. 6B is a schematic diagram of the overboil ring apparatus used with a cooking utensil

FIG. 6C is a schematic diagram of the overboil ring apparatus overboil showing a sealing function on the rim of a cooking basin.

FIG. 7 is a view of the overboil ring apparatus that is folded approximately halfway between the inner and outer edges.

FIG. 8 shows a cooking basket inserted into the overboil ring apparatus, being held by the overboil ring apparatus where the cooking system is placed into a pot.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

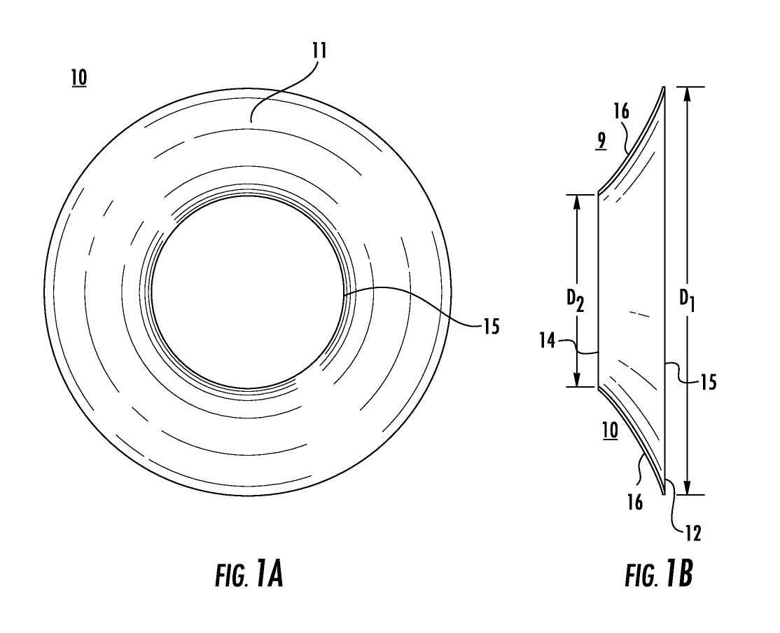

FIGS. 1-5 illustrate overboil ring apparatus 10 in accordance with the teachings of the present invention. Overboil ring apparatus 10 comprises ring 11 having a symmetric and decreasing diameter at different heights of the ring providing a frusto-conical shape. Outer ring portion 12 has diameter D₁ which is greater than inner ring portion 14 diameter D₂. Opening 15 is formed within inner ring portion 14. A suitable diameter for opening 15 is in the range of about 3 to about 9 inches, preferably 6 inches. For example, the dimensions for the overboil ring apparatus can be a height H₁ of about 50 mm, outer ring diameter D₁ of 300 mm, and inner ring diameter D₂ of 140 mm. Sides 16 of overboil ring apparatus 10 can have varying thicknesses. For example the thickness of overboil ring apparatus 10 can be between about 1.8 mm and 3.2 mm, for folding and flexibility properties. In an alternate embodiment, overboil ring apparatus 10 can have dimension of a height H₁ if 56.7 mm, outer ring diameter D₁ of 340 mm, inner ring diameter D₂ of 158.7 mm. In this embodiment, for example, an average thickness of overboil ring 10 can be between about 1.4 mm and about 4 mm.

Angle A₁ is formed between inner ring portion 14 and outer ring portion 12. For example, angle A₁ can be in a range of about 20 to about 60 degrees, preferably about 25 to about 35 degrees. Overboil ring apparatus 10 has a decreasing diameter at lower heights between outer ring portion 12 and inner ring portion 14.

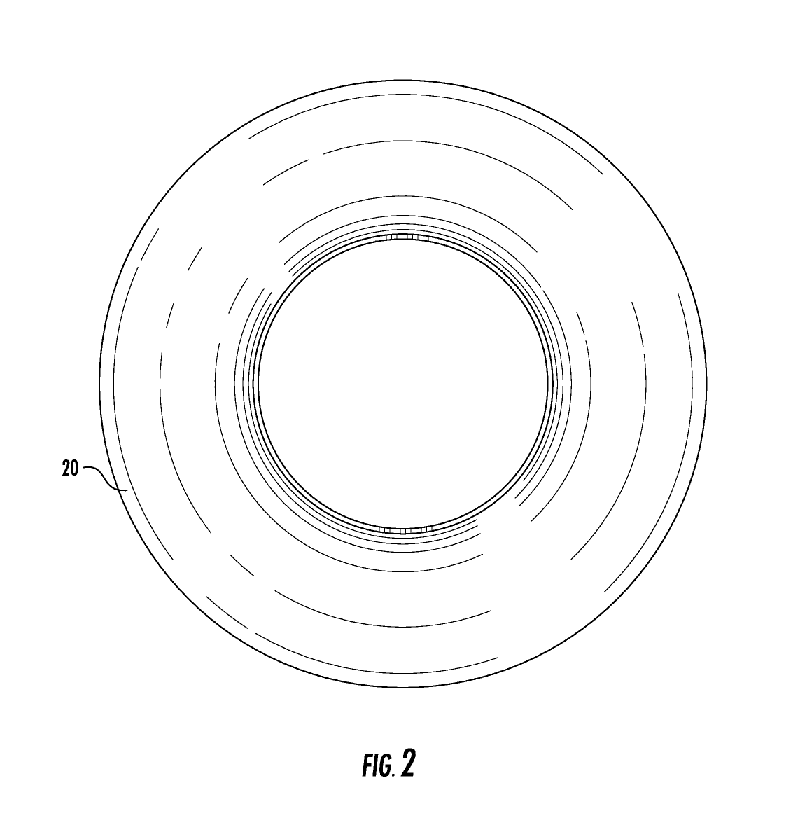

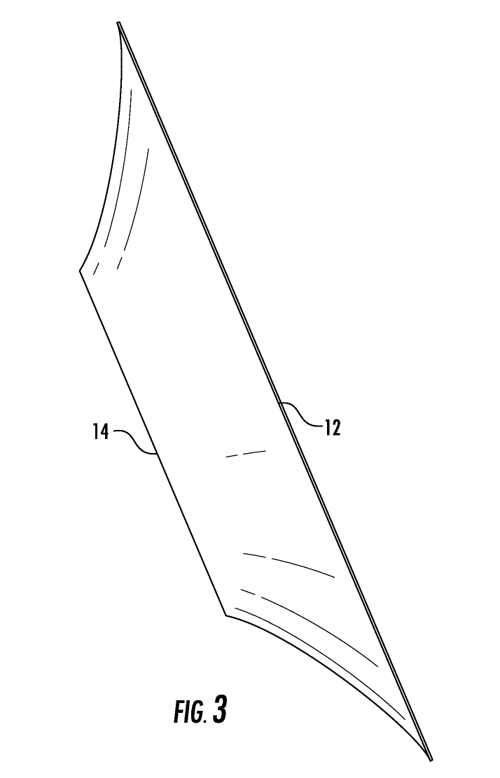

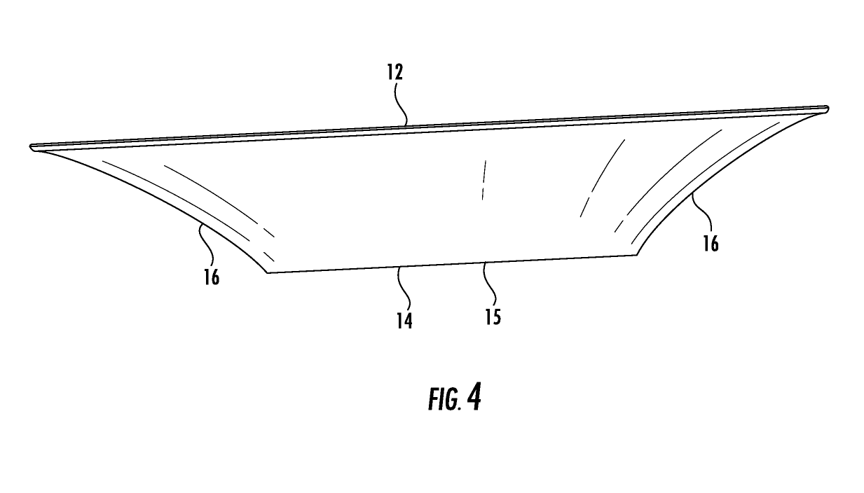

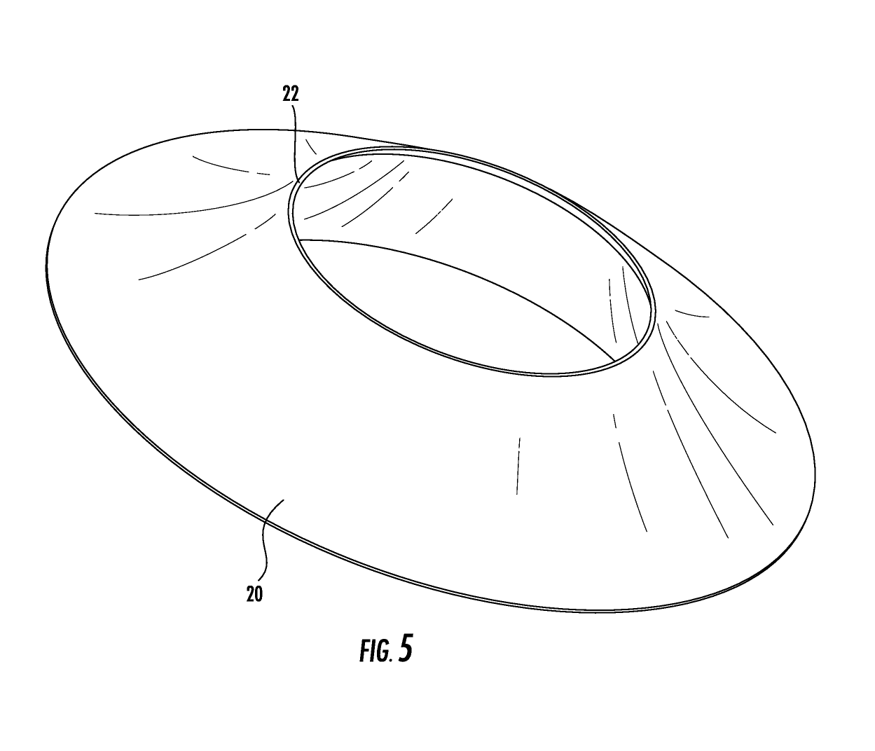

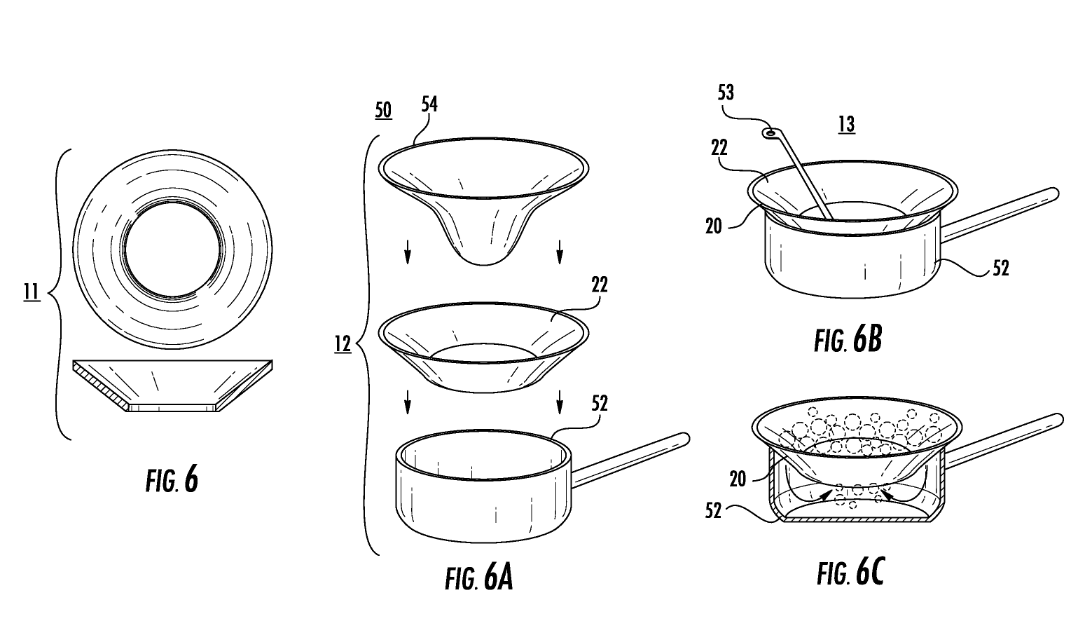

FIG. 2 depicts overboil ring apparatus 10 from the bottom. Outer surface 20 of overboil ring apparatus 10 can be substantially smooth Inner surface 22 of overboil ring apparatus 10 can be substantially smooth as shown in FIGS. 5 and 6. FIGS. 3 and 4 show a version of overboil ring apparatus 10 from the side. Sides 16 can be formed with a convex, concave, or straight edges from outer ring portion 12 to inner ring portion 14.

FIGS. 6A-6C show overboil ring apparatus 10 used in cooking system 50. Cooking system 50 includes cooking or heating apparatus 52 and optionally one or more cooking utensils 53 and/or cooking basket 54. For example, cooking or heating apparatus 52 can be a pot, pan, or other cooking or heating basin. Overboil ring apparatus 10 is placed over cooking and heating apparatus 52 and rests upon cooking or heating apparatus 52. Cooking basket 54 can be optionally received in opening 15 of inner ring portion 14. Basket 54 can be inserted through inner ring portion 14. Cooking basket 54 is optionally added to cook or heat foods or other products, for example eggs, pastas, rices, or any other material to be heated while in a liquid within cooking and heating apparatus 52, for example oil or water. Cooking basket 54 can optionally be used for steaming, and can optionally be used to infuse foods and other products with certain flavors and other characteristics, such as through the use of herbs, oils, juices, soups, or other heated liquids and semi-liquids.

One or more cooking utensils 53 can received in opening 15 of inner ring portion 14. Cooking utensil 53 can rest against inner surface 22 of overboil ring apparatus 10 as shown in FIG. 6B. The smooth outer surface 20 of overboil ring apparatus 10, the material making up overboil ring apparatus 10, and the weight of overboil ring apparatus 10 contribute to a strong seal between overboil ring apparatus 10 and cooking or heating apparatus 52. Due to contributions from coefficients of friction of material forming overboil ring apparatus 10, and due to the angle of overboil ring apparatus 10, overboil ring apparatus 10 provides a steady location for resting cooking utensils during the cooking process, or for resting foods or other solids prior to adding the foods or other solids to cooking or heating apparatus 52.

One embodiment of overboil ring apparatus 10 is made of silicone, where the coefficient of friction and chemical properties of silicone provide additional benefits of a secure seal between overboil ring apparatus 10 and cooking or heating apparatus 52, and sufficient friction for resting utensils on the overboil ring apparatus 10. Alternatively, overboil ring apparatus 10 is formed of plastic or rubber or silicone rubber.

While overboil ring apparatus 10 defends the user and the cooking or heating surface from overboiling, splatters, spills, or splashes, the user may concomitantly monitor, see, smell, stir, or add materials to the liquids in the pot, pan, or cooking basin. A lid may optionally be used above the ring, while the ring is placed upon the pot, pan, or cooking basin.

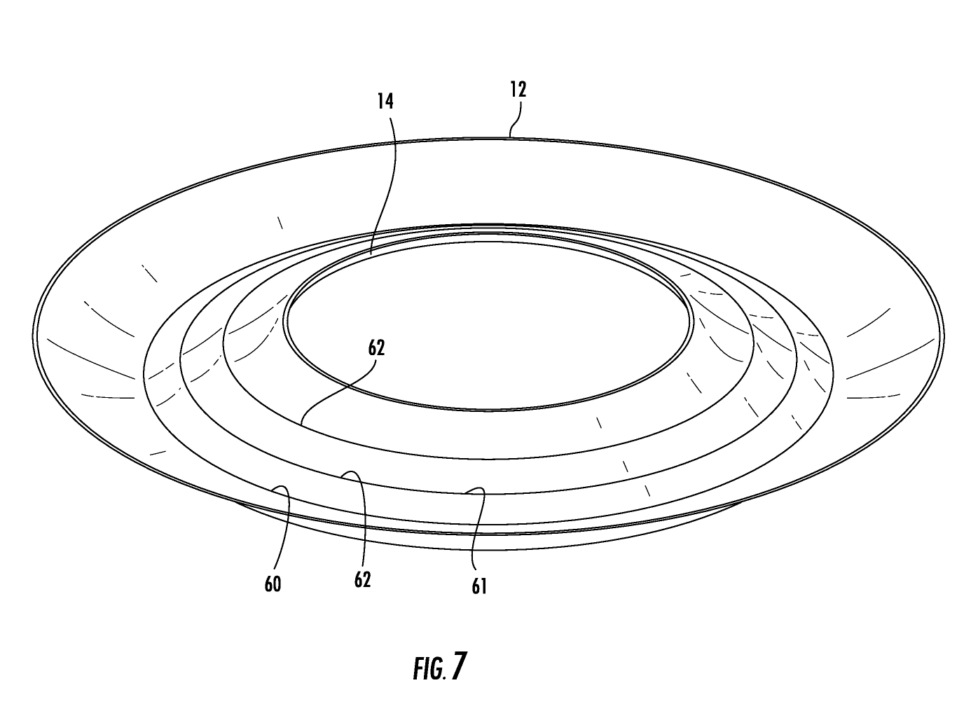

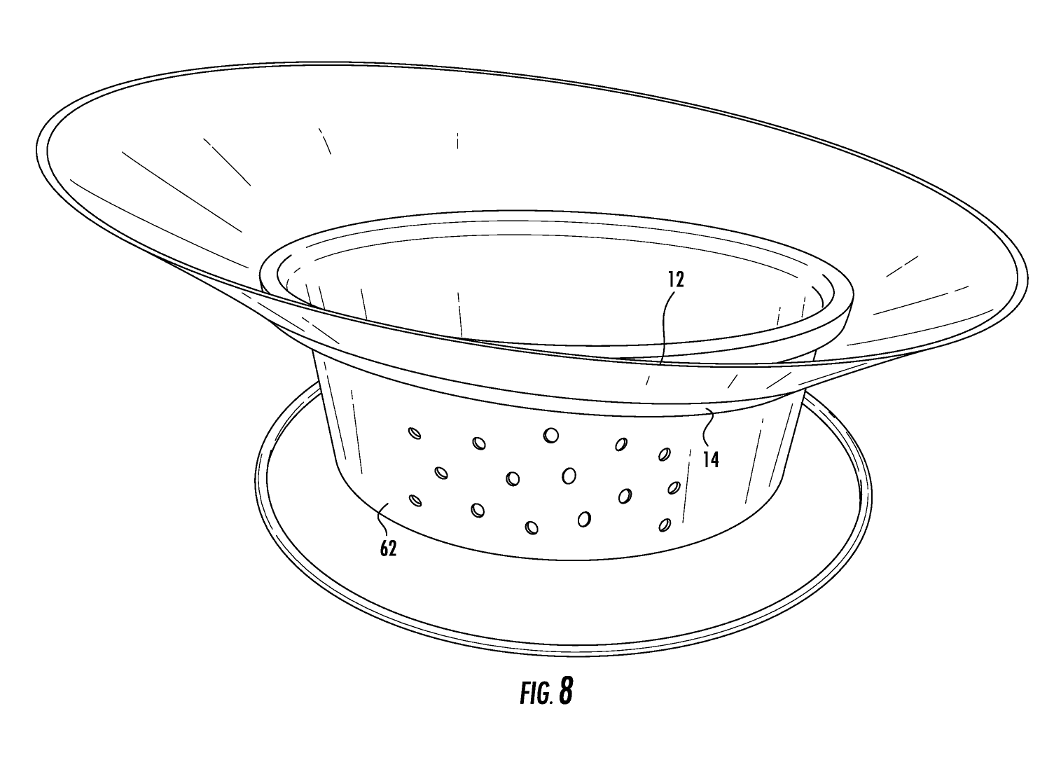

In one embodiment overboil ring apparatus 10 includes a fold 60 positioned between outer ring portion 12 and inner ring portion 14 approximately halfway between the inner ring portion 14 and outer ring portion 12 as shown in FIG. 7 Inner surface 61 of overboil ring apparatus 10 can include one or more ridges 62 as shown in FIGS. 7 and 8. Overboil ring apparatus 10 can optionally be folded, which provides the benefits of stability for holding cooking materials, saving storage space, and preventing splatter from cooking or heating products. Overboil ring apparatus 10 may optionally be used upside down, where outer ring portion 12 is below inner ring portion 14, when the overboil ring apparatus 10 is placed upon cooking or heating apparatus 52, for preventing splashes when stirring or blending liquids, semi-liquids, and combinations of liquids and solids or semi-solid products, in the cooking or heating apparatus 52.

A method of cooking or heating products comprises pacing overboil ring apparatus 10 over cooking and heating apparatus 52. One or more cooking utensils 53 or cooking basket 54 can be presented through opening 15 in inner ring portion 14.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. An overboil ring apparatus comprising:
a ring having a symmetric and decreasing diameter at lower heights between an outer ring portion and an inner ring portion,
the inner ring portion of the ring being angled to the outer portion of the ring, said inner ring portion having an opening therein.

2. The overboil ring apparatus of claim 1 wherein the angle between the inner ring portion and the outer ring portion is in a range of about 20 degrees to about 60 degrees.

3. The overboil ring apparatus of claim 1 wherein the angle between the inner ring portion and the outer ring portion is in a range of about 25 degrees to about 35 degrees.

4. The overboil ring apparatus of claim 1 wherein said ring is formed of silicone.

5. The overboil ring apparatus of claim 1 wherein an outside surface of said ring is substantially smooth.

6. The overboil ring apparatus of claim 1 wherein sides between said inner ring portion and said out ring portion are formed with convex, concave or straight edges.

7. The overboil ring apparatus of claim 1 wherein said inner ring portion is adapted to receive a cooking utensil.

8. The overboil ring apparatus of claim 1 wherein said inner ring portion is adapted to receive a cooking basket.

9. The overboil ring apparatus of claim 1 wherein said ring includes one or more ridges on an inner surface of said ring.

10. The overboil ring apparatus of claim 1 wherein said ring includes a fold positioned between said inner ring portion and said outer ring portion.

11. A cooking system comprising a ring having a symmetric and decreasing diameter at lower heights between an outer ring portion and an inner ring portion,
the inner ring portion of the ring being angled to the outer portion of the ring, said inner ring portion having an opening therein and
optionally a cooking utensil and/or a cooking basket.

12. The cooking system of claim 11 wherein the angle between the inner ring portion and the outer ring portion is in a range of about 20 degrees to about 60 degrees.

13. The cooking system of claim 11 wherein the angle between the inner ring portion and the outer ring portion is in a range of about 25 degrees to about 35 degrees.

14. The cooking system of claim 11 wherein said ring is formed of silicone.

15. The cooking system of claim 11 wherein an outside surface of said ring is substantially smooth.

16. The cooking system of claim 11 wherein sides between said inner ring portion and said out ring portion are formed with convex, concave or straight edges.

17. The cooking system of claim 11 wherein said inner ring portion is adapted to receive a cooking utensil.

18. The cooking system of claim 11 wherein said inner ring portion is adapted to receive a cooking basket.

19. The cooking system of claim 11 wherein said ring includes one or more ridges on an inner surface of said ring.

20. The cooking system of claim 11 wherein said ring includes a fold positioned between said inner ring portion and said outer ring portion.

21. A method of cooking or heating products comprising:
providing an overboil ring apparatus comprising:
a ring having a symmetric and decreasing diameter at lower heights between an outer ring portion and an inner ring portion,
the inner ring portion of the ring being angled to the outer portion of the ring, said inner ring portion having an opening therein; and
placing the overboil ring apparatus above a cooking or heating apparatus.
